(19) United States
(12) Patent Application Publication
(10) Pub. No.: US 2008/0010441 A1
(43) Pub. Date: Jan. 10, 2008

(54) MEANS FOR SUPPORTING AND TRACKING A LARGE NUMBER OF IN-FLIGHT LOADS IN AN OUT-OF-ORDER PROCESSOR

(75) Inventors: Erik R. Altman, Danbury, CT (US); Vijayalakshmi Srinivasan, New York, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/428,589

(22) Filed: Jul. 5, 2006

(51) Int. Cl. G06F 9/44

(52) U.S. Cl. 712/225

(57) ABSTRACT

A method for supporting and tracking a plurality of loads in an out-of-order processor being run by a program includes executing instructions on the processor, the instructions including an address from which data is to be loaded and memory locations from which load data is received, determining inputs of the instructions, determining a function unit on which to execute the instructions, storing the plurality of instructions in both a LRQ and a LIP queue, the LRQ comprising a list of the plurality of stores and the LIP comprising a list of respective addresses of the plurality of loads, dividing the LIP into a set of congruence classes, each holding a predetermined number of the loads, allowing the loads to be stored in the memory locations, snooping the load data, and allowing a plurality of snoops to selectively invalidate the load data from snooped addresses so as to maintain sequential load consistency.

### GOVERNMENT INTEREST

This invention was made with Government support under contract No.: NBCH3039004 awarded by Defense Advanced Research Projects Agency (DARPA). The government has certain rights in this invention.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to out-of-order processors, and particularly to a partition of a storage location into two storage locations: one a Load Reorder Queue (LRQ) and one a Load Issued Prematurely (LIP) queue.

2. Description of Background

In out-of-order processors, instructions may be executed in an order other than what the predetermined program specifies. For an instruction to execute on an out-of-order processor, three conditions normally need to be satisfied: (1) the availability of inputs to the instruction, (2) the availability of a function unit on which to execute the instruction, and (3) the existence of a location to store a result.

For most instructions, these requirements are usually satisfied. However, for load instructions, accurately determining condition (1) is difficult. Load instructions (“loads”) have two types of inputs: (a) registers, which specify an address from which data is to be loaded, and (b) a memory location(s) from which load data is received from. The determination of the availability of register values in case (a) is usually satisfied. However, determining the availability of memory locations in case (b) is not a straightforward determination.

The problem with memory locations is that there may be a plurality of stores to the memory locations that may not have completed their execution and have not stored their values in the memory hierarchy. In other words, (1) when all of the register inputs for the load instruction are ready, (2) there is a function unit available on which the load can be executed, and (3) there is a place (a register) in which to put the loaded value. Since earlier stores have not yet executed, it may be that the data locations to which these stores write, are some of the same data locations from which the load reads. In general, without executing the store instructions, it is not possible to determine if the address (i.e., data locations) to which a store writes overlaps the address from which a load reads.

As a result, most out-of-order processors execute load instructions when (1) all of the input register values are available, (2) there is a function unit available on which to execute the load, and (3) there is a register where the loaded value may be placed. Since dependences on previous store instructions are ignored, a load instruction may sometimes execute prematurely, and have to be squashed and re-executed so as to obtain the correct value produced by the store instruction.

Another related problem arises when a processor is one of a plurality of processors in a multiprocessor (MP) system. Different MP systems have different rules for the ordering of load and store instructions executed on different processors. At a minimum, most MP processors require a condition known as a “sequential load consistency,” which means that if processor X stores to a particular location A, then all loads from location A on processor Y must be consistent. In other words, if an older load on processor Y sees the updated value at location A, then any younger load on processor Y must also see that updated value. If all of the loads on processor Y were executed in order, such “sequential load consistency” would occur naturally. However, on an out-of-order processor, the younger load in order may execute earlier than the older load in order. If processor X updates the location from which these two loads read, then “sequential load consistency” is violated.

The traditional solution is to keep a list of loads that are in some stage of execution. This list is sometimes referred to as the Load-Reorder-Queue (LRQ). This LRQ list is sorted by the order of loads in the program. Each entry in the LRQ has, among other information, the address(es) from which the load received data. Each time a store executes, it checks the LRQ to determine if any loads, which are after the store in, program order.

In other words, a store checks every “in-flight” load instruction to determine if there is an error. An “in-flight” store instruction is one that has been fetched and decoded, but which has not yet been “completed”, i.e., placed its value in the memory hierarchy. “Completed” means that the store and all instructions in the program prior to the store have finished executing, and thus each of these instructions can be represented to the programmer or anyone viewing execution of the program. The term “retired” is sometimes used as a synonym for “completed.”

Moreover, each time a processor writes to a particular location, it informs every other processor that it has done so. In practice, most processor systems have mechanisms that avoid the need to inform every processor of every individual store performed by other processor. However even with these mechanisms, there is some subset of stores about which other processors must be informed. When a processor Y receives notice (a “snoop”) that another processor X has written to a location, processor Y must ensure that all of the loads currently “in-flight” receive “sequentially load consistent” values. All entries in the LRQ, which match the snoop address, have a “snooped” bit set to indicate that they match the snoop. All load instructions check this snooped bit when they execute.

There may be many loads “in-flight” at any one time: modern processors allow 16, 32, 64 or more loads to be simultaneously “in-flight.” Thus, a store instruction must check 16, 32, 64, or more entries in the LRQ to determine if those loads executed prematurely. Likewise, a “snoop” must check 16, 32, 64, or more entries in the LRQ to determine if there is a potential violation of “sequential load consistency.”

Since new load instructions and store instructions may occur each cycle in a modern processor, these “forwarding” checks must take at most one cycle, i.e., all 16, 32, 64 or more entries in the SRQ must be able to be checked every cycle. Such a “fully associative” comparison is known to be expensive (a) in terms of the area required to perform the comparison, (b) in terms of the amount of energy required to perform the comparison, and (c) in terms of the time required to perform the comparison. In other words, a cycle may have to take longer than it otherwise would so as to allow time for the comparison to complete. All three of these factors are significant concerns in the design of modern processors, and improved solutions are important to continued processor improvement.

Thus, it is well known to forward data from in-flight stores to loads (executed by a load instruction) by keeping a list of stores that are in some stage of execution. However, in existing storage mechanisms since new load instructions may occur each cycle in a modern processor, these “forwarding” checks must (i) take at most one cycle and (ii) entries in the SRQ must be able to be checked every cycle, which is very expensive and time-consuming.

### SUMMARY OF THE INVENTION

The shortcomings of the prior art are overcome and additional advantages are provided through the provision of a method for supporting and tracking a plurality of stores in an out-of-order processor running one or more programs, the method comprising: executing a plurality of instructions on the out-of-order processor, each of the plurality of instructions including an address from which data is to be loaded and a plurality of memory locations from which load data is received from; determining inputs of the plurality of instructions; determining a function unit on which to execute the plurality of instructions; storing the plurality of instructions in both a Load Reorder Queue (LRQ) and a Load Issued Prematurely (LIP) queue, the LRQ comprising a list of the plurality of stores and the LIP comprising a list of respective addresses of the plurality of stores; dividing the LIP into a set of congruence classes, each of the congruence classes holding a predetermined number of the plurality of stores; allowing the plurality of stores to be stored in the plurality of memory locations; snooping the load data; and allowing a plurality of snoops to selectively invalidate the load data from snooped addresses so as to maintain sequential load consistency.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that detects when a load instruction has executed prematurely and missed receiving data from a previous store instruction. Thus, this invention solves any problems of detecting violations of “sequential load consistency.”

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a Load Reorder Queue (LRQ);

FIG. 2 illustrates one example of a Load Issued Prematurely (LIP) queue;

FIG. 3 illustrates one example of the LIP (Load Issued Prematurely) queue and one example of the LRQ (Load Reorder Queue) of a load instruction for a dispatch command;

FIG. 4 illustrates one example of a flowchart for a load instruction for a dispatch command;

FIG. 5 illustrates one example of the LIP and of the LRQ for a load instruction for an issue command;

FIG. 6 illustrates one example of a flowchart for a load instruction for an issue command;

FIG. 7 illustrates one example of an LRQ size; and

FIG. 8 illustrates one example of an LIP size.

### DETAILED DESCRIPTION OF THE INVENTION

One aspect of the exemplary embodiments is detection of when a load instruction has executed prematurely and missed receiving data from a previous store instruction. Another aspect of the exemplary embodiments is detection of violations of “sequential load consistency.”

In the exemplary embodiments of the present application a storage unit is divided into two parts. The first part is referred to herein as the LRQ, which is a list of in-flight loads, sorted by the program order of the loads. However, each entry is smaller, and in particular need not contain the address from which the load obtained its data.

Instead, such addresses can be kept in another structure referred to herein as the LIP, which is the “Load Issued Prematurely.” In order to mitigate the problems with area, power, and cycle time described above, the LIP has a structure similar to a cache. In particular, it is divided into a set of congruence classes, each able to hold information about a small number (e.g., 4 or 8) loads at any one time. With these congruence classes, stores and snoops need only check a small number of loads (e.g., 4 or 8) in order to determine if some sort of error has occurred requiring one or more loads to re-execute. As a result of having to check fewer loads, the exemplary embodiments requires less area and power, and can execute load instructions with a smaller cycle time, approximately 30-35% improved over previous in-flight stores in out-of-order processors.

The congruence class into which each load is placed in the LIP depends on some subset of the bits in the address from which the load reads. Typically the bits determining congruence classes are from the lower order bits of the address, as these tend to be more random and help spread entries around, and avoids over-subscribing any particular congruence class.

The LIP and the LRQ are synchronized. The description below discusses how the exemplary embodiments of the present application behave during different phases of load execution, store execution, and snoops.

One purpose of the dual structure is (1) to track load order, (2) to allow stores to snoop loads, and (3) to allow snoops to selectively invalidate loads from the snooped address so as to maintain sequential load consistency.

The LRQ structure of the exemplary embodiments of the present application is as follows:

LRQ=Load Reorder Queue, which is a FIFO structure, i.e., loads enter at dispatch time and leave at completion/retire time.

LIP=Load Issued Prematurely, which is a cache-like structure indexed by address. Loads enter at issue time, or when the real address of the load is known. Loads exit at completion/retire time in program order.

The two main registers are: LRQ_HEAD=Index into LRQ of oldest load in flight and LRQ_TAIL=Index into LRQ of youngest load in flight.

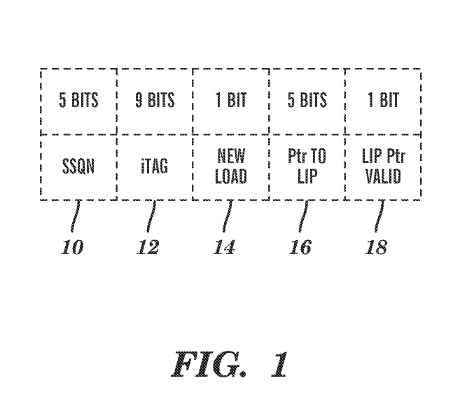

FIG. 1 illustrates an LRQ entry. The LRQ entry contains an SSQN entry 10, a iTag entry 12, a New Load entry 14, a Ptr to LIP entry 16, and a LIP Ptr Valid entry 18.

The SSQN entry 10 is a Store Sequence Number, which informs load L what stores are older than L and what stores are younger than L.

The iTag entry 12 is a Global Instruction Tag, i.e., a unique identifier for this instruction distinguishing it from all other instructions in flight.

The New Load entry 14 is load instructions that may be divided or “cracked” into multiple simpler microinstructions or “IOPS.” The “New Load” flag indicates if this load is first IOP of a load instruction.

The Ptr to LIP entry 16 is an index into LIP structure for this load. In the exemplary embodiment, this index directly indicates the position of the load in the LIP, not the position in the congruence class of the LIP.

The LIP Ptr Valid entry 18 indicates if there is a corresponding LIP entry for this load, and hence whether the “Ptr to LIP” field should be ignored.

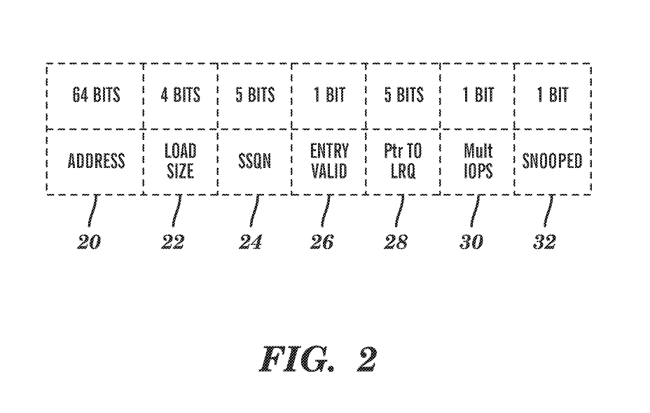

FIG. 2 illustrates an LIP entry. The LIP entry contains

An Address entry 20 being an Address/Data Location from which load instruction reads.

A Load Size entry 22 being a Number of Bytes at “Address” which load instruction reads.

An SSQN entry 24 being a Store Sequence number, as described above with reference to FIG. 1 for LRQ.

An Entry Valid entry 26 being an entry that contains valid and useful data.

A Ptr to LRQ entry 28 being an index to the corresponding LRQ entry.

A Mult IOPS entry 30 being load instructions that may be divided or “cracked” into multiple simpler microinstructions or “IOPS.” The “Mult IOPS” flag indicates if this load is such an instruction.

A snooped entry 32 for snooping loads.

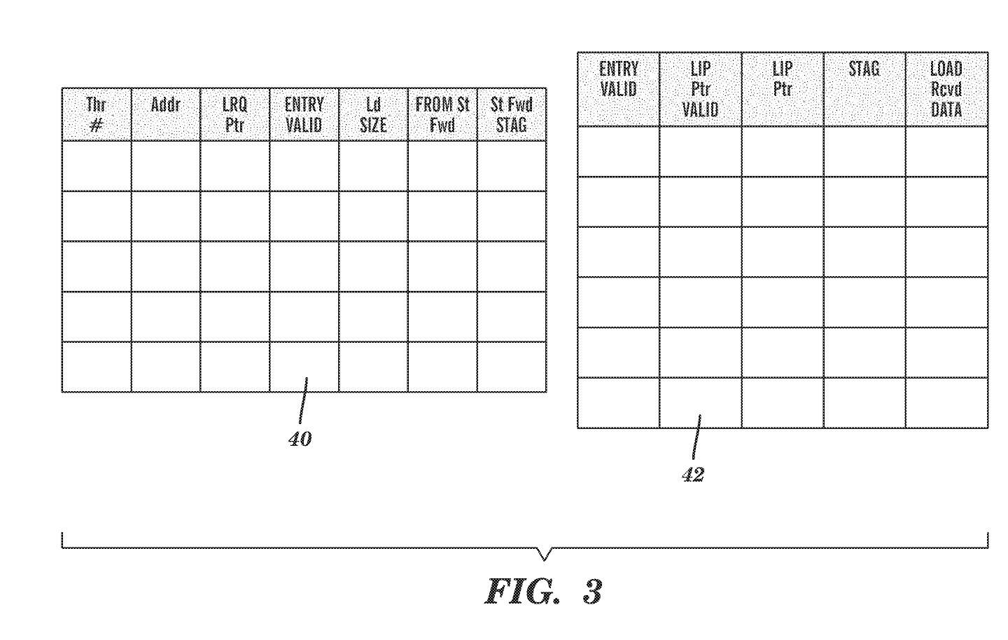

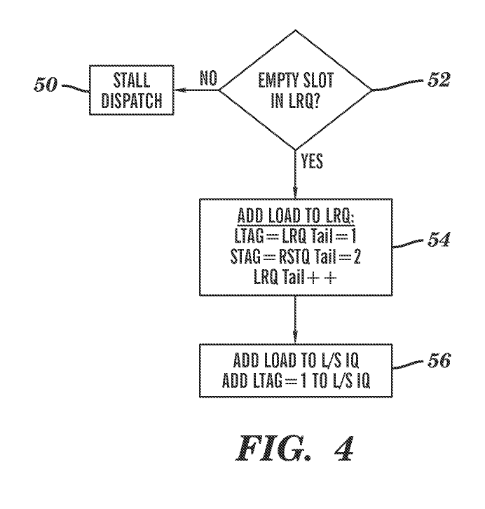

FIG. 3 illustrates one example of the LIP (Table 40) and the LRQ (Table 42) for a load instruction dispatch command and FIG. 4 illustrates one example of a flowchart for a load instruction for a dispatch command. Table 40 of FIG. 3 receives entries of a load instruction for a dispatch command in columns: Thread Number, Address, LRQ Ptr, Entry Valid, Ld Size, From St Fwd, and St Fwd STAG. Table 42 of FIG. 3 receives entries of a load instruction for a dispatch command in columns: Entry valid, LIP Ptr Valid, LIP Ptr, STAG, and Load Rcvd Data. FIG. 4 illustrates the process of executing the dispatch portion a load instruction. At step 52 it is determined whether the LRQ contains an empty slot. If not empty slot is determined, then the process flows to step 50 where the load dispatch command is stalled. If an empty slot is determined then the process flows to step 54 where the dispatch command is loaded to the LRQ. Once the dispatch command is loaded the process flows to step 56 where the dispatch command is loaded to the L/S IQ.

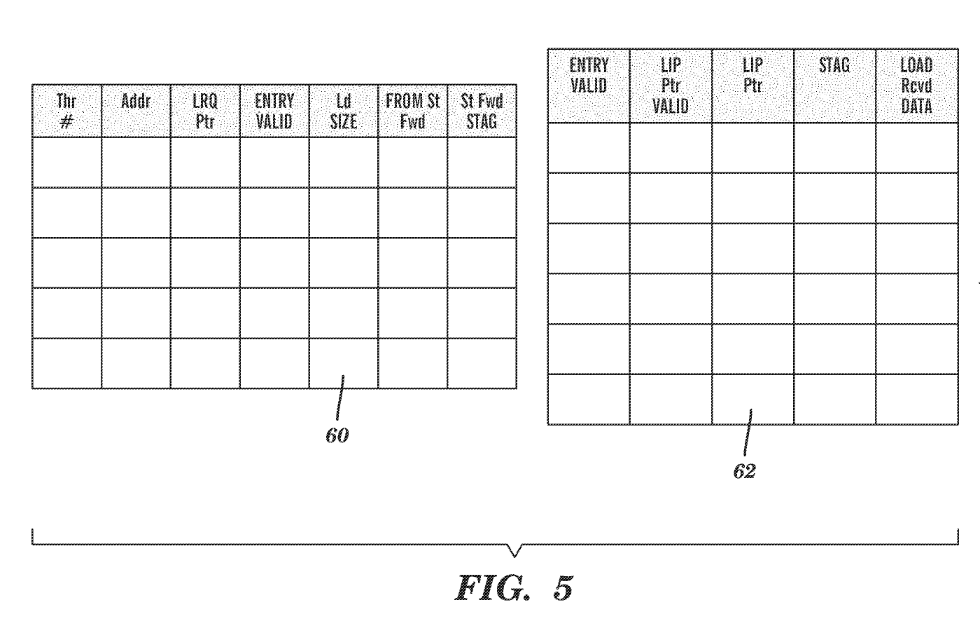

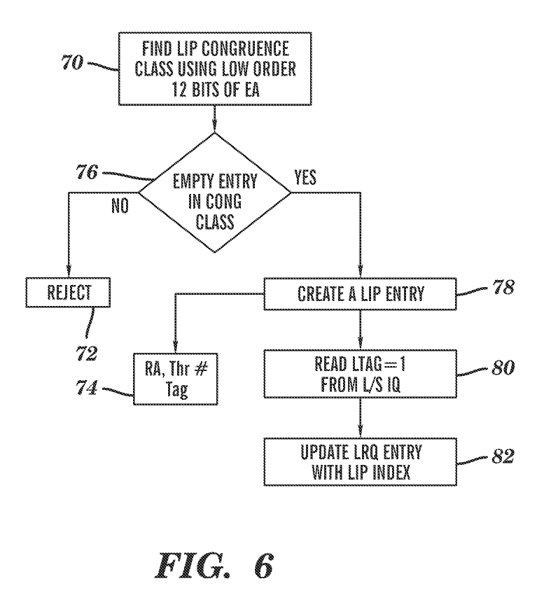

FIG. 5 illustrates one example of the LIP (Table 60) and the LRQ (Table 62) of a load instruction for an issue command and FIG. 6 illustrates one example of a flowchart for a load instruction for an issue command. Table 60 of FIG. 5 receives entries of a load instruction for an issue command in columns: Thread Number, Address, LRQ Ptr, Entry Valid, Ld Size, From St Fwd, and St Fwd STAG. Table 62 of FIG. 5 receives entries of a load instruction for an issue command in columns: Entry valid, LIP Ptr Valid, LIP Ptr, STAG, and Load Rcvd Data. FIG. 6 illustrates the process of executing the issue portion of a load instruction. At step 70 the LIP congruence class is determined. At step 76 it is determined if the congruence class contains an empty entry. If there is no empty entry then the process flows to step 72 where the process is terminated. If there is an empty entry then the process flows to step 78 where a LIP entry is created. At step 80 the LIP entry is read and at step 82 the LRQ entry is updated with the Lip entry read in step 80. Also, when a LIP entry is created at step 78 the process flows to step 74 where RA, Thread Number, and Tag entries are entered into table 60 of FIG. 5.

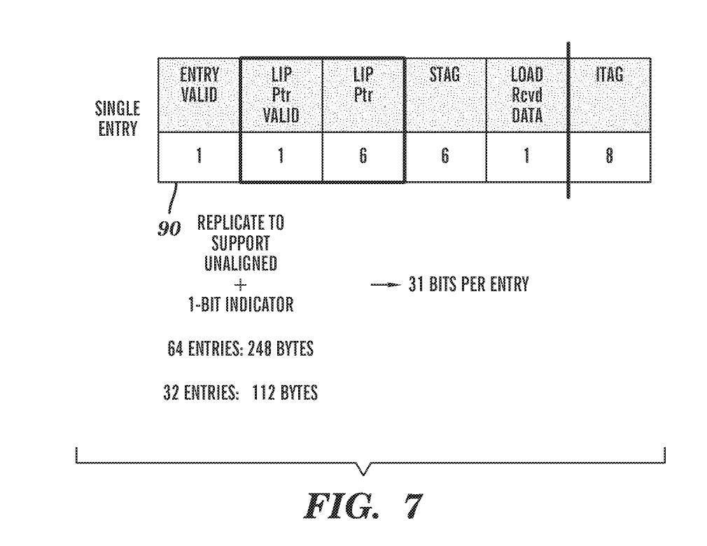

Referring to FIG. 7, a sample size of the LRQ is shown. For example, for 64 entries into table 40 and table 42 of FIG. 3, the size of the LRQ is 248 bytes. For example, for 32 entries into table 40 and table 42 of FIG. 3, the size of the LRQ is 112 bytes.

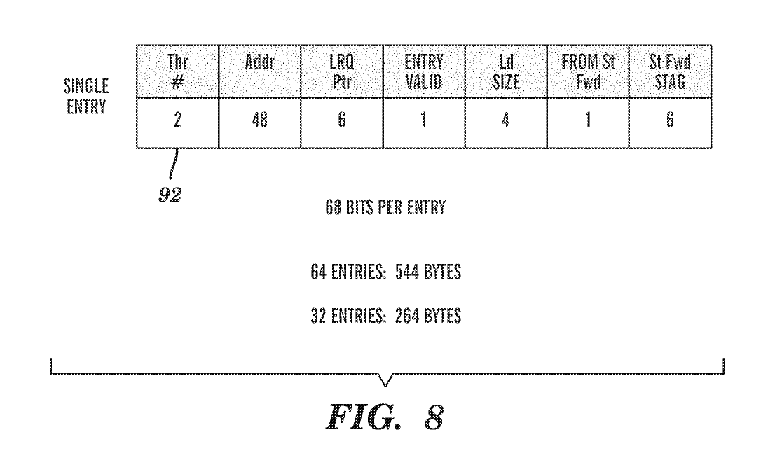

Referring to FIG. 8, a sample size of the LIP is shown. For example, for 64 entries into table 60 and table 62 of FIG. 5, the size of the LIP is 544 bytes. For example, for 32 entries into table 60 and table 62 of FIG. 5, the size of the LIP is 264 bytes.

Additional fields that may be added to the LRQ and the LIP structures are Simultaneous Multi-Threading (SMT) fields and unaligned accesses fields. These additional fields would add 2 bits per LIP entry and 7-9 bits per LRQ entry. Also, for the total size of the LRQ and LIP structures it is assumed that, for illustrative purposes, there are 32 entries in both the LRQ and the LIP, and that the total storage for the structures is: LRQ: 32 entries×27 bits/entry=864 bits==>108 bytes and LIP: 32 entries×81 bits/entry=2592 bits==>324 bytes.

Furthermore, one of the key elements of LIP sizing is the granularity of its entries. Small regions have the benefit of tending to spread entries throughout the LIP. With 1-byte granularity, two adjacent byte loads would be in different congruence classes. However, small regions have the drawback of requiring multiple entries for a single load. With 1-byte granularity, a 4-byte load would require 4 entries, thus one entry in each of 4 congruence classes. Also, small regions have the drawback of requiring multiple checks for a single store or snoop. With 1-byte granularity, a 4-byte store would check for overlaps in 4 congruence classes. Snoops are generally at a cache line granularity, e.g., 128 bytes, and with 1-byte granularity in the LIP, snoops would look at 128 congruence classes. Compromise values for granularity are 8 or 16 bytes, and the exemplary embodiments employ one of these two values.

Concerning the operation of structures for load instructions, the following sequence is followed for LOAD DISPATCH, for LOAD ISSUE, and for LOAD RETIRE:

LOAD DISPATCH: When load instruction enters an issue queue in program order. The following steps are executed: (1) Put LRQ_TAIL (youngest) in LD/ST issue queue so can immediately find LRQ entry when load issues, (2) Set “SSQN” field in entry at LRQ_TAIL to value of the RSTQ tail, (3) Set “iTag” field in entry at LRQ_TAIL to global instruction tag for this IOP, (4) Set “New Load” bit in entry at LRQ_TAIL for the first IOP from an (architected) load instruction, (5) Clear “LIP Ptr Valid” field in entry at LRQ_TAIL, (6) The Load Sequence Number (LSQN) for this load is the value of LRQ_TAIL. Note that the position of the load in the LRQ also indicates the LSQN, and (7) Bump LRQ_TAIL.

LOAD ISSUE: When a load instruction leaves an issue queue to actually execute. The following steps are executed: (1) Put the load in the LIP:

(a) If there is an entry in the congruence class with “Entry Valid” cleared, then use that entry and set the “Entry Valid” field. If an entry is available: (A) Set “Address” field with real address, (B) Set “Load Size,” (C) Set “SSQN” field from issue queue or LRQ, (D) Set “Entry Valid,” (E) Set “Ptr to LRQ,” and (F) Set “Mult IOPS” if there are other IOPS for this load.

(b) Otherwise reject the load, i.e., cause it to be re-executed (the LIP is full and cannot accommodate it). Rejection can use the “iTag” field of the corresponding LRQ entry to tell the issue queue the identity of the rejected load.

(c) The check for an available LIP slot can begin relatively early after load issue. For plausible LIP sizes, no address bits beyond the 12 LSB are used to find the congruence class, and the 12 LSB are computed as part of the effective or virtual address. Translation to the real address is not required.

The next two steps involve the execution of: (2) If there any younger loads in the LIP reading from the same address and with the SNOOPED bit set, then require those other loads to re-execute, and (3) Before checking the LIP, stores wait a sufficient number of cycles after they issue to ensure that all loads issued before the store are in the LIP.

LOAD RETIRE: When a load and all previous instructions in program order have finished execution and hence the load can be fully completed or “retired” from in-flight status. The following steps are executed: (1) Check if the “LIP Ptr Valid” bit is set for the load's LRQ entry. If so clear the “Entry Valid” field in the LIP entry, and (2) Bump the LRQ_HEAD pointer.

Concerning the operation of structures for store instructions, the following sequence is followed for STORE ISSUE:

STORE ISSUE: When a store instruction leaves an issue queue, the following sequence of events is executed: (1) Using the store address, check the LIP for matching loads in the congruence class for the address:

(a) To match the store, a load entry in the LIP must: (A) Be younger than the store, and (B) Overlap the range of bytes being stored. The age comparison for (A) can be done by comparing the “SSQN” in the LIP entry with the SSQN of the store provided from the Load/Store Issue Queue.

The overlapping byte comparison for (B) can be more formally stated as follows: LAST STORE BYTE>=FIRST LOAD BYTE and FIRST STORE BYTE<=LAST LOAD BYTE.

In terms of the structures and values, for a store to match a LIP entry and cause a load reject (i.e., re-execution), the conditions are: STORE.Address+STORE.Size>LIP.Address and STORE.Address<LIP.Address+LIP.Size.

In two cases, multiple accesses are required for the LIP: Case 1: Stores spanning the boundary of a LIP entry, e.g., an 8-byte store beginning at address 0xC (using hexadecimal notation from the C language). 4-byte loads at 0xC and at 0x10 would each overlap the store, but would be in different LIP congruence classes, assuming 16-byte granularity for LIP entries. Case 2: Stores larger than the granularity of a LIP entry. For example, if LIP entries have an 8-byte granularity, then a 16-byte store would examine at least two LIP congruence classes. If the 16-byte store were not aligned on a 16-byte boundary, then three LIP congruence classes would be checked. Furthermore, snoops may examine 8 or 16 (all) congruence classes if the snoop granularity is a 128-byte cache line, and the LIP granularity is 16 or 8 bytes.

(b) If a store address matches one or more LIP entries, then for each such entry: (A) Reject the load in the entry and cause it to be re-executed. Rejection can use the “iTag” fields of the corresponding LRQ entries to tell the issue queue the identities of the rejected loads. (B) Remove the entry from the LIP: (i) Clear the “Entry Valid” field in the LIP entry, and (ii) Clear the “LIP Ptr Valid” field in the corresponding LRQ entry.

(c) A LIP entry may be only one part of a larger load instruction. For example, a PowerPC LMW (Load Multiple Word) instruction may have multiple LIP entries, one for each cracked/millicoded portion. A store instruction may overlap part of the address range of the LMW instruction, but not all of it, and thus match only a subset of the cracked/millicoded ops represented in the LIP. One of the cracked/millicoded ops from a large load may execute prematurely, i.e., the before the data from an overlapping store was available for forwarding. In this case, in order to maintain atomicity of the large load, not only the offending cracked/millicoded op must be rejected, but all other cracked/millicoded ops from the large load.

As a result, if the “Mult IOPS” bit is set in a LIP entry, and that entry executed prematurely, several additional steps must be taken: (A) Using the “Ptr to LRQ” field of the LIP entry, find the LRQ entry, Q, corresponding to the errant LIP entry. (B) Starting from Q, walk the LRQ in both directions—towards LRQ_HEAD and LRQ_TAIL, until each is reached or until the entry corresponds to an architected load other than the Load with the snooped LIP entry. In other words, walk LRQ entries until the “New Load” field is encountered. (C) At each entry, Q′ of the LRQ where before a “New Load” is encountered: (1) If “LIP Ptr Valid” is set, then find the corresponding LIP entry using the “Ptr to LIP” field of Q′, (2) Reset the “Entry Valid” field of the LIP entry, (3) Reset the “LIP Ptr Valid” field of the LRQ entry, Q′, and (4) Reject the load and tell the rest of the processor to reissue the iop corresponding to “iTag.”

Concerning the operation of structures on snoops, the following sequence is followed for snoops: The goal is to use the same mechanism to handle snoops from other threads on the same processor as for snoops from other processors. The approach that is followed is just as with step (1a) of STORE ISSUE, use the address being snooped to check the LIP for matching loads in the congruence class for the address.

Unlike stores, the age of the load is ignored, since the instructions in two threads are unordered with respect to each other. As noted in the discussion of STORE ISSUE, the granularity of the comparison is a cache line as opposed to the size of an individual store instruction. Thus, unless the granularity of LIP entries is a cache line size or larger, multiple probes of the LIP are required to complete the snoop. If the snoop is from another processor then the “ThreadID” should be ignored in determining if the snoop matches a LIP entry. If the snoop is from another thread on the same processor, then it can determine the single other thread on the processor whose loads should be snooped. If a snoop address matches one or more LIP entries, then for each such entry, set its SNOOPED bit.

In addition, the description of the LRQ and LIP has largely ignored threading within a processor. A single processor employing Simultaneous Multi-Threading (SMT) may execute instructions from multiple programs or “threads” simultaneously. With N thread SMT, the LRQ entries would probably be coarsely and equally divided among the N threads. In addition, the two registers described, LRQ_HEAD and LRQ_TAIL, would have N replicas, one per thread. Moreover, there could either be N LIP structures so as to allow one structure per thread, or there could be one large LIP structure shared among whatever threads are running. One large structure would require augmenting the “Address” field tag in the LIP with a 2-bit “ThreadID” tag.

In probing the LIP: (1) Matching a store from the same thread requires that both the “Address” and “ThreadID” fields match, i.e., in addition to having overlapping addresses, the load and store must be from the same thread. (2) Matching a snoop from another processor requires that the “Address” field match, and that the “ThreadID” field be ignored.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for supporting and tracking a plurality of loads in an out-of-order processor being run by a predetermined program, the method comprising:
executing a plurality of instructions on the out-of-order processor, each of the plurality of instructions including an address from which data is to be loaded and a plurality of memory locations from which load data is received;
determining inputs of the plurality of instructions;
determining a function unit on which to execute the plurality of instructions;
storing the plurality of instructions in both a Load Reorder Queue (LRQ) and a Load Issued Prematurely (LIP) queue, the LRQ comprising a list of the plurality of loads and the LIP comprising a list of respective addresses of the plurality of loads;
dividing the LIP into a set of congruence classes, each of the congruence classes holding a predetermined number of the plurality of loads;
allowing the plurality of loads to be loaded from a plurality of memory locations;
snooping the load data; and
allowing a plurality of snoops to selectively invalidate the load data from snooped addresses so as to maintain sequential load consistency.

2. The method of claim 1, wherein the plurality of instructions are load instructions.

3. The method of claim 1, wherein the plurality of instructions are in-flight load instructions.

4. The method of claim 1, wherein the LRQ and the LIP are synchronized.

5. The method of claim 1, wherein the LRQ is a cache-like structure having the congruence classes, each of the congruence classes being a subset of low order address bits, or some other function of the address bits including additional information.

6. The method of claim 1, wherein the LRQ is enabled by First-Input First-Output (FIFO) behavior that permits each of the plurality of loads to enter into a program order executed by the predetermined program only after being decoded.

7. The method of claim 1, wherein the LRQ contains at least two registers, a first of which comprises an index in the LRQ of the oldest load in-flight and a second of which comprises an index in the LRQ of the youngest load in-flight.

8. The method of claim 1, wherein the LIP has a structure that includes an address field, a load size field, a store sequence number field, an entry valid field, an index to corresponding LRQ entry field, a load instruction field, and a snoop field.

9. The method of claim 8, wherein the structure of the LIP further includes a plurality of simultaneous multi-threading fields and a plurality of unaligned access fields.

10. The method of claim 1, wherein the size of the LIP depends on the granularity of the load data.

11. The method of claim 10, wherein the granularity is a 1-byte granularity that allows the load data to be in separate congruence classes.

12. The method of claim 10, wherein the granularity is an 8-byte, 16-byte or other granularity sufficient to allow the load data to be in separate congruence classes.
